(19) United States
(12) Patent Application Publication
(10) Pub. No.: US 2019/0375278 A1
(43) Pub. Date: Dec. 12, 2019

(54) ADDITIVELY MANUFACTURED STRUCTURES FOR VEHICLE DOORS

(71) Applicant: DIVERGENT TECHNOLOGIES, INC., Los Angeles, CA (US)

(72) Inventors: Jon Paul GUNNER, Los Angeles, CA (US); Ross Harrison BYERS, Los Angeles, CA (US); July AYE, Los Angeles, CA (US)

(21) Appl. No.: 16/431,621

(22) Filed: Jun. 4, 2019

Related U.S. Application Data
(60) Provisional application No. 62/681,582, filed on Jun. 6, 2018.

(51) Int. Cl. B60J 5/04; B33Y 80/00; B33Y 10/00

(52) U.S. Cl. CPC B60J 5/0463; B60J 5/0486; B33Y 10/00; B33Y 80/00

(57) ABSTRACT

Techniques for using additively manufactured structures for doors are disclosed. These structures may include complex features and interfaces to enable connections to various systems in a door. The AM structure can include fasteners, hinges, hinge attachments and other structures which can advantageously be printed with the AM door structures.

### BACKGROUND

### Field

The present disclosure relates generally to additively manufactured doors in vehicles and transport mechansisms.

### Introduction

This disclosure presents an additively manufacturered door structure for use in vehicles and other transport mechanisms such as automobiles, trains, trucks, busses, boats, sea vessels, submarines, aircraft, spacecraft, and the like. Traditional door structures used in vehicles and other transport mechanisms are conventionally manufactured using stamping, casting, and rendering composite panels composed of a plurality of materials. These techniques, and necessary enhancements or augmentations to the door structures, are expensive. Where tooling is involved, these techniques are not only costly and inflexible, but also are constrained by the dimensional and material limitations inherent in tooling.

Besides the door panel itself, these modern door structures are commonly connected to ever more sophisticated components and systems requiring new or different structural and functional interfaces. Setting aside the intricacies of design evolution in themselves, the requirements for new and expensive manufacturing equipment with distinct capabilities to accommodate new designs give rise to additional capital expenditures.

In short, given the conventional limitations inherent in existing door structures and associated manufacturing techniques (including the inefficiencies in tooling and similar methods), the potentially exorbitant capital expenditures that must be levied to attempt to overcome such obstacles are increasingly impractical. In short, there is a need to develop flexible, robust, safe, and tech-savvy door structures and related components that are no longer circumscribed by these constraints.

### SUMMARY

According to one aspect of the disclosure, a door structure includes at least one additively manufactured (AM) section, and a plurality of sections coupled together at least in part by adhesive bonds, wherein the AM section is optimized to meet strength to weight performance metrics.

According to another aspect of the disclosure, a door for a vehicle or a mechanized assembly includes a plurality of additively manufactured (AM) structures configured to reinforce a corresponding plurality of modular sections; and a plurality of functional sections.

According to another aspect of the disclosure, a method for manufacturing a door for a vehicle or mechanized assembly includes additively manufacturing a plurality of AM sections, curing a composite outer on a composite outer tool, clamping the AM sections during an adhesive cure to bond the AM sections using clamps located on the composite outer tool, and clamping the plurality of AM sections to the composite outer during another adhesive cure to bond the AM sections to the composite outer.

### DESCRIPTION OF THE DRAWINGS

FIG. 1 is a side image of an exemplary door structure according to the invention, including various AM sections defined by particular boundaries in the structure.

FIG. 2. is an exemplary image of AM door structure under assembly.

FIG. 3 is an conceptual flow diagram showing the various steps of assembling the exemplary door structure of FIG. 2.

### DETAILED DESCRIPTION

A flexible system to additively manufacture door structures is disclosed herein. Additive manufacturing (“AM”), i.e., three-dimensional (“3-D”) printing, is a non-design specific manufacturing tool that eliminates common design restrictions and accords the designer virtually limitless design freedom to manufacturer new door structures and related interfaces and connections. This new degree of design freedom can be performed at a fraction of the overall cost of using conventional methods, the latter wherein either the design freedom is restricted and the capital expenditures are substantial.

This disclosure presents AM door structures and exemplary methods for building and 3-D printing the same, wherein such structures and methods overcome the conventional structures and techniques. The “doors” or “door structures” as used interchangeably herein may also include separate interface and connectors to which the door is directly or indirectly coupled. The disclosure presents an AM door structure for use in vehicles. The disclosure, however, is not intended to be limited to passenger vehicles and includes any personal or commercial transport mechanism, manned or unmanned, and including by way of example trains, busses, boats, sea vessels, submarines, aircraft, spacecraft, and the like.

As referenced above, conventional door structures are produced using stampings, castings, composite panels, and tooling. The complexity of the door structures is often driven by the need for sophisticated connections used to enable the door to interface with the necessary internal components and systems, for example to accomplish the functions for which it is intended. This need in turn can fulfill one of several structural and functional requirements of the overall door structure. Unlike conventional systems (and among other differences), the herein-described flexible system enables the manufacturer to produce door structures without the design, tooling and monetary constraints faced by current vehicle manufacturers.

AM. Additive manufacturing (“3-D Printing”) provides a significant advantage over traditional manufacturing technologies in that it is non-design specific. Unlike tooling, casting, stamping, and other techniques, AM may be used to build a wide variety of parts with varying material density, complex internal structures such as lattices, and geometries. Where the build piece is larger than the substrate or print bed, (a phenomenon which is becoming less frequent as print bed sizes and laser beam numbers for 3-D printers are progressively increasing), the 3-D printer can print a portion of the structure on one pass, then the remaining structure(s) on subsequent pass(es). Additively manufactured structures can be optimized to meet specific strength-to-weight performance metrics while retaining any necessary external geometric profiles. The design freedom afforded by AM would provide car manufacturers the ability to make optimized door structures.

AM makes possible the fabrication of thinner and more complex structures that cannot be manufactured utilizing stampings, the latter of which are conventionally performed for door manufacturing in the automobile industry today. Present AM technologies, including PBF (powder bed fusion) DED (direct energy deposition), and many others can overcome these and other limitations on part thickness and geometries. A variety of 3-D printing technologies may also be employed, some of which may overlap with the PBF and DED printing techniques. These include, for example, Stereolithography (SLA), Digital Light Processing (DLP), Selective Laser Sintering (SLS), Selective Laser Melting (SLM), Laminated Object Manufacturing (LOM), Binder Jetting (BJ), Material Jetting (MJ), and others. Any one or more of these AM-based technologies may be used herein.

AM door structures are disclosed in this invention. The structure may be broken down into multiple functionally driven sections to implement a modular assembly. In some embodiments, this method would use adhesive bonds to connect the various sections of the door structure. The joints between the various sections can either be single shear, double shear, or a mix of both single and double shear adhesive bonds, depending on the door and panel requirements. In some embodiments, the tongue-and groove joints can provide the connection between the sections. The flanges and overlap sections between the sections would define the adhesive region to form the connection. The sections can additionally have adhesive inlet and outlet ports for adhesive introduction, and channels to transfer adhesive between the sections to realize the bond. However, these sections can also utilize other mechanical fastening methods to assemble the sections. Mechanical reinforcements (e.g. ribs, structural lattices, etc.) can be provided in regions requiring them, and these can be either co-printed with the sections, or provided separately.

Furthermore, the structure can integrate mounting points for all internal and external interfaces, including crash beams. In some embodiments, the crash beams can be fully integrated into one (or more) of the sections by co-printing. In other embodiments, the crash beams may be mechanically fastened or adhesively bonded to the structure.

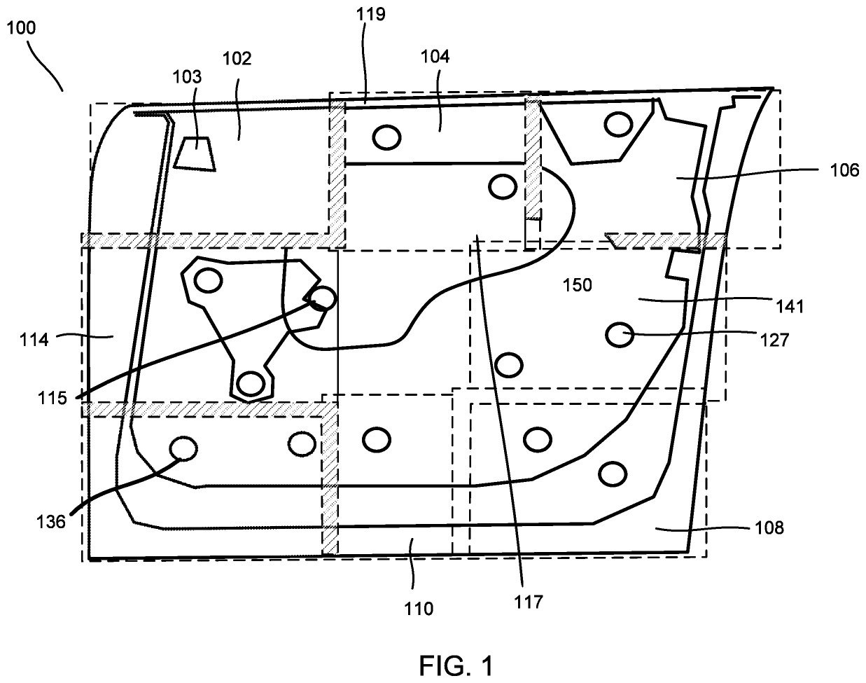

FIG. 1 is a side image of an exemplary door structure 100 including various AM sections defined by particular boundaries in the structure 100 labeled by the numerical references. The dashed boundary traversing between certain of the sections depicts the adhesive bond/connection between the sections, determined in part by the load requirements.

The door structure may comprise multiple sections that are broken down into multiple functionally driven subsections to realize modular assembly. In some embodiments, this method can use adhesive bonds to connect the various sections of the door structure 100. The sections would define the adhesive region to form the connection. The sections can additionally have adhesive inlet and outlet ports for adhesive introduction, and channels to transfer adhesive between the sections to realize the bond. For example, in an embodiment, aperture 136 may include a channel for adhesive inlet or outlet, e.g., to secure an AM door panel to the remainder of the door structure 100. However, these sections can also utilize other mechanical fastening methods to assemble the sections.

Mechanical reinforcements (e.g. ribs, structural lattices, etc.) can be provided in regions requiring them, and these can be either co-printed with the sections, or provided separately. Furthermore, the structure can integrate mounting points for all internal and external interfaces, including crash beams. In some embodiments, the crash beams can be fully integrated into one (or more) of the sections by co-printing. In other embodiments, the crash beams may be mechanically fastened or adhesively bonded to the structure. The following image depicts an exemplary door structure with the various AM sections bound by dashed boundaries. The dashed boundary between the sections depicts the adhesive bond/connection between the sections, determined by the load requirements as described further with respect to FIG. 1, below.

Referring to FIG. 1, the door structure 100 may be 3-D printed in whole or in part. In an embodiment, the entire door structure is 3-D printed and is done so to precisely match the specifications for certain connection points and to seamlessly fit within the body of the vehicle. Mirror mount section 102, on the upper left of the door mount structure, may be printed, e.g. to provide a side view for the driver. Section 102 may be modular in nature, with compartment 103 designed to receive the side mirror (not shown). Additional hardware may optionally be used for this connection, such as a pin extending through the side mirror, to secure the side mirror and mirror mount section.

A modular hinge section 114 may be positioned in this embodiment toward the middle side front of the vehicle. Hinge section 114 may include a simple gap designed to meet a modular protrusion on a body of the vehicle. Alternatively, hinge section may include a plurality of 3-D printed metal protrusions that extend into one or more cavities of the vehicle. Hinge section 114 in this embodiment is required to have enough strength to maintain the attachment of door structure 100 to the vehicle under the most adverse conditions of wind, speed, strong turns, and even vehicle impacts.

Sections 115 and 117 may be used to secure the various modular sections of the interior of the door structure 100 to its exterior. Alternatively or additionally, section 115 may be used as an armrest, with the hinges on section 117 configured to prevent the armrest from undesirable forward movement. Grab handle section 104 may include apertures into which a standard vehicular grab handle may be arranged, or similar retaining hardware. Grab handles are handles that a passenger can grab for support, e.g., in the event the vehicle is involved in a sharp turn or other event that throws the passenger off balance.

In many door structures, the vehicle may have a sizeable window presence. The window's position can vary widely. In some cases, the window is aligned above the door structure 100 and may be coupled to the door structure from above. With reference to the door structure 100 in the illustration, a lower portion of the window may be seated in a cavity 119 in an embodiment. In another embodiment, sections 115 and 117, which in above embodiments secured various interior elements to exterior ones, may alternatively or additionally include sections for retaining windows, where feature 115 is used to secure the window to a desired opening. In this embodiment, window may be shown in part by window section 117. Other embodiments may not necessitate a window, at least of the type found in commercial vehicles.

Inner handle section 106 may include a space for an inner handle secured to an interior portion of the right door panel 100. Immediately below the inner handle section 106 is a latch section 141. In the embodiment shown, the door structure 100 is layered as a plurality of structural panels. A robust set of connecting devices (not shown) that engage with apertures 127 may be configured to be attached to the vehicle frame or the door structure 100, and may be used to provide a standard latch mechanism to move the door into an open or closed position. In alternative embodiments, apertures may be used to seal a reinforcing member (e.g., member 150) to the outer frame of the door structure 100 using a technique described herein.

The lower portion 108 of the door structure 100 may include one or more t sections 110.

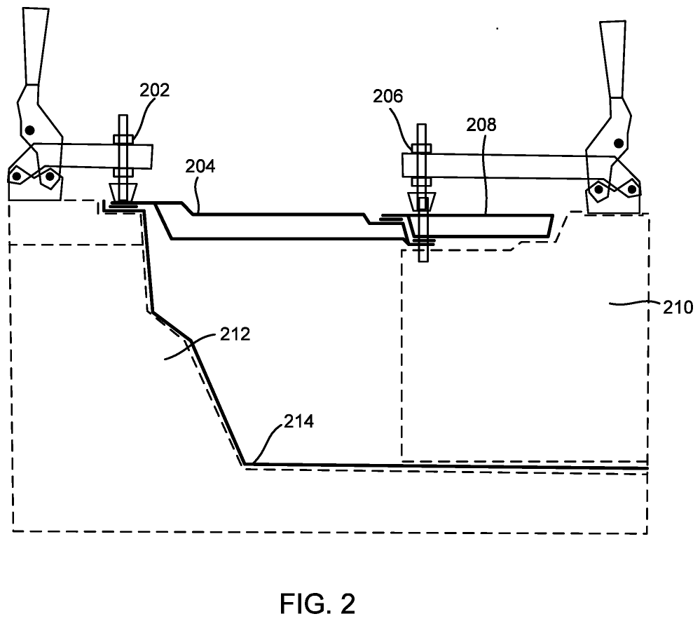

Manufacturing/Assembly. FIG. 2 is an exemplary image of an AM door structure under assembly. In an embodiment, the various sections of the AM structure can be fixtured/clamped together via clamps 202/206 (with optional pin locators shown adjacent the clamps) during the adhesive cure. In an embodiment, they may be clamped to the composite door outer tool 212. In this embodiment, the composite door outer tool would initially be used to cure the composite outer structure 214. Upon completion of the cure of the composite outer 214 on the composite outer tool 212, the clamps 202 and 206 may be secured to a corner AM section 204 and a mid AM section 208 to allow for adhesive to cure between the AM sections. (AM sections 204 and 208 represent 3-D printed structures for interfacing with a variety of diverse features and are useful, for example, to facilitate the curing stage of a vehicle door frame). Subsequently or simultaneously in some embodiments, clamps may clamp AM sections to the composite outer 214 to facilitate and complete adhesive bonding between them. That is, the sections of the AM structure can be clamped via clamps 202/206 to the composite outer 214 while adhesive cures between them. The clamps and pin locators on the composite tool and nodes may locate and clamp the AM sections to each other, as well as to the cured outer skin or composite outer 214. Once curing is complete, the clamps 202/206 may be released for removal of the integrated assembly along with adjacent pin locators.

Using additively manufactured structures for door structures has numerous advantages. These structures may include complex self-fixturing features and interfaces to enable connections to various systems in a door. The AM structures can include fasteners, hinges, hinge attachments, etc., which can advantageously be co-printed with the AM door sections. These features may need to be sealed prior to certain post-processing operations, such as E-Coating. These features may need to be plugged during the E-Coating process to prevent them from seizing up. By plugging them, they would still float during the assembly, but would be coated during the E-Coating process, as mandated by corrosion protection requirements. Once the assembly is complete, the features can be locked in place with an adhesive when they are in the right position. This could be applied to the entire floating fastener scheme as well, not just the door hinges. This could include body attachments, grilles, etc. The design would allow for updates of systems, because of the modularity provided by the functional-driven sections of AM door structures. For example, in embodiments where the sections are mechanically fastened, a section interfacing with a speaker system can be easily removed and updated with a new speaker system. When other systems need to be updated, the CAD of the sections can be updated prior to printing and can be printed to accommodate the updated systems, as opposed to re-tooling to manufacture updated door structures utilizing conventional manufacturing processes.

The AM sections can provide greater packaging flexibility for improved aesthetics and can easily accommodate alternate outer door materials. Traditional systems are limited by depth of draw/cast tool sizing. The design freedom afforded by AM is not restricted by traditional manufacturing limitations. Currently, the greatest draw depths are achieved using superplastic forming of sheet metal, or composite construction.

These structures can also be used for HVAC (Heating, Ventilation, Air Conditioning) systems. Channels and ducts may be co-printed as features with these sections for routing air through the door sections. These sections can additionally be defined by the mechanical reinforcement features discussed above (e.g. ribs, structural lattices, etc.). Additively manufacturing door sections augments the multifunctionality nature of the door sections. Furthermore, the AM door sections provide the capability to realize multi-material connections to manufacture doors with high strength-to-weight ratios. Isolation strategies (e.g. spacers, sealants, gaskets, etc.) between galvanically incompatible materials may be advantageously provided in these sections by incorporating features to ensure that no physical contact occurs between the incompatible materials while still realizing a connection between them.

AM further provides a platform to tune the stiffness and modal response of the door structure to obtain a specific quality feel during vehicle operation.

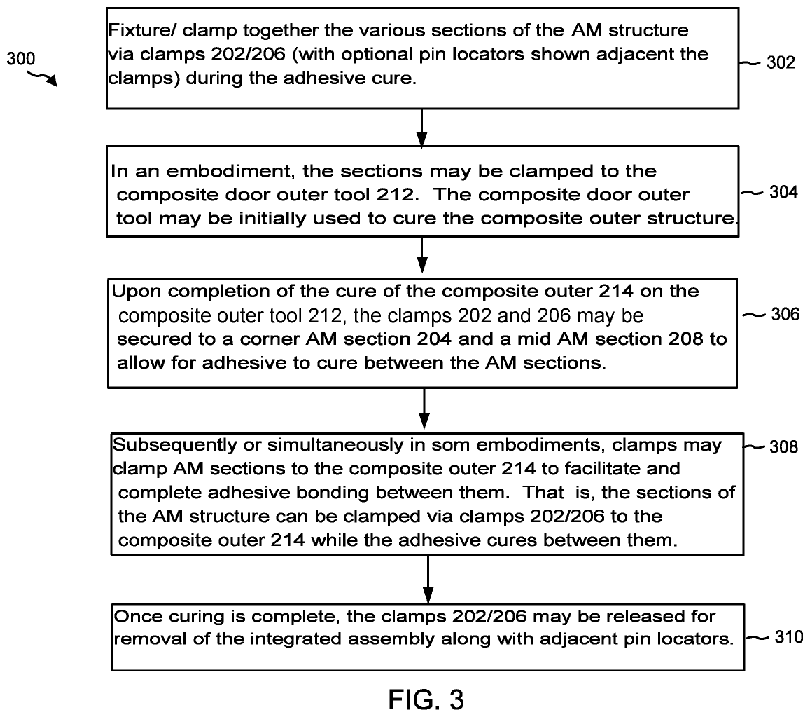

FIG. 3 is a conceptual flow diagram 300 showing the various steps of assembling the exemplary door structure of FIG. 2. Beginning at step 302, the various sections of the AM structure are fixtured/clamped together via claims 202/206 (with optional pin locators shown adjacent the clamps) during the adhesive cure.

At step 304 in an embodiment, the AM sections may be clamped to the composite door outer tool 212. The composite door outer tool is initially used to cure the composite outer structure 214. At step 306, upon completion of the cure of the composite outer 214 on the composite outer tool 212, claims 202 and 206 may be secured to a corner AM section 204 and a mid AM section 208 to allow for the adhesive to cure between the AM sections.

At step 308, subsequently or simultaneously in some embodiments, clamps may clamp AM sections to the composite outer 214 to facilitate and complete adhesive bonding between them. That is, the sections of the AM structure can be clamped via clamps 202/206 to the composite outer 214 while the adhesive cures between them.

At step 310, once curing is complete, clamps 202/206 may be released for removal of the integrated assembly along with adjacent pin locators.

The previous description is provided to enable any person skilled in the art to practice the various aspects described herein. Various modifications to the exemplary embodiments presented throughout this disclosure will be readily apparent to those skilled in the art, and the concepts disclosed herein may be applied to other objects besides vehicles. Thus, the claims are not intended to be limited to the exemplary embodiments presented throughout the disclosure, but are to be accorded the full scope consistent with the language claims. All structural and functional equivalents to the elements of the exemplary embodiments described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), or analogous law in applicable jurisdictions, unless the element is expressly recited using the phrase “means for” or, in the case of a method claim, the element is recited using the phrase “step for.”

What is claimed is:

1. A door structure, comprising:
at least one additively manufactured (AM) section;
a plurality of sections coupled together at least in part by respective adhesive bonds, wherein the AM section is optimized to meet strength to weight performance metrics.

2. The door structure of claim 1, further comprising an AM reinforcement configured to have a smaller strength-to-size ratio than conventionally built components.

3. The door structure of claim 1, wherein the plurality of sections are 3-D printed.

4. The door structure of claim 1, further comprising a plurality of AM mechanical reinforcements in positions requiring them.

5. The door structure of claim 1, further comprising one or more co-printed crash beams integrated at mounting points of the at least one AM section.

6. The door structure of claim 1, further including one or more fastener, hinge, or hinge attachment co-printed with the at least one AM section.

7. A door for a vehicle or a mechanized assembly, comprising:
a plurality of additively manufactured (AM) structures configured to reinforce a corresponding plurality of modular sections; and
a plurality of functional sections.

8. The door of claim 7, further comprising a mirror mount section.

9. The door of claim 7, further comprising a grab handle section.

10. The door of claim 7, further comprising a latch section for coupling the door to a vehicle frame.

11. The door of claim 7, further comprising a glass drop motor section.

12. The door of claim 7, further comprising a hinge section.

13. The door of claim 7, further comprising a regulator section.

14. A method for manufacturing a door for a vehicle or mechanized assembly, comprising:
additively manufacturing a plurality of AM sections;
curing a composite outer on a composite outer tool;
clamping the AM sections during an adhesive cure to bond the AM sections using clamps located on the composite outer tool; and
clamping the plurality of AM sections to the composite outer during another adhesive cure to bond the AM sections to the composite outer.

15. The method of claim 14, further comprising:
on completion of the curing, locating clamps and pin locators on the composite outer tool to locations and clamps on each other.

16. The method of claim 14, comprising:
using the clamps and pin locators on the tool to locate and clamp the composite outer; and
allowing the composite outer to cure.

17. The method of claim 14, wherein upon completion of the curing, the clamps are located to the cured outer skin.

18. The method of claim 16, comprising using AM sections to increase door strength.
